(19) United States
(12) Patent Application Publication
(10) Pub. No.: US 2008/0149241 A1
(43) Pub. Date: Jun. 26, 2008

(54) Pneumatic Tire

(75) Inventors: Hirokatsu Maruyama, Kanagawa (JP); Takumi Morito, Kanagawa (JP)

Correspondence Address: GREER, BURNS & CRAIN, 300 S WACKER DR, 25TH FLOOR, CHICAGO, IL, 60606, US

(73) Assignee: YOKOHAMA RUBBER CO., LTD., Minato-ku, Tokyo (JP)

(21) Appl. No.: 11/793,507

(22) PCT Filed: Sep. 12, 2006
(86) PCT No.: PCT/JP2006/318077

§ 371 Date: Jun. 19, 2007

(30) Foreign Application Priority Data
Nov. 9, 2005 (JP) 2005-325060

(51) Int. Cl. B60C 11/01; B60C 11/13

(52) U.S. Cl. 152/209.16; 152/209.18

(57) ABSTRACT

A plurality of main grooves extending in a tire circumferential direction and a plurality of sub grooves that communicates with the main grooves are formed in a tread portion. A plurality of central land portions is formed in a block shape by the main grooves and the sub grooves, and a plurality of shoulder land portions is formed in a rib shape by the main grooves. A ratio A of a total groove area to an area of a region of a tread development width satisfies 0.25≦A≦0.32, and a ratio B of the total groove area to an area of a region between the right and left shoulder land portions satisfies 0.35≦B≦0.45.

### TECHNICAL FIELD

The present invention relates to a pneumatic tire, and more specifically, to a pneumatic tire having improved uneven-wear resistance and improved wet resistance.

### BACKGROUND ART

With a recent regulation on overloading, a mainstream of cargo vehicles in Japan is a vehicle having a gross vehicle weight of 25 tons. In most of 6×2 vehicles excluding recent vehicles (such as an 8×4 vehicle), tires in the tire size of 295/80R22.5 are installed on the front side and tires in the tire size of 11R22.5 are installed on the rear side. In other words, in those vehicles, tires of different sizes are installed on the front side and on the rear side. Therefore, because the positions of the tires are limited, a tire rotation cannot be performed even when the tires are unevenly worn. This results in a problem that an uneven tread wear, such as a shoulder wear or a wave wear, tends to occur in the shoulder land portions of the tires on the front side (in a rib or a block).

In vehicles for foreign markets, an installation pattern of tires is employed for each purpose. For example, rib tires having excellent uneven-wear resistance are installed on the front side, and traction (all-weather-applicable) tires having excellent wet resistance are installed on the rear side. However, vehicles for the Japanese market are required to have high wet performance and to have tires with a snow stamp (a stamp required during traffic control on a snowy day). For this reason, the installation of the rib tires on the front side only cannot meet such requirements sufficiently. Accordingly, it is required to install tires having both excellent uneven-wear resistance and excellent wet resistance on the front side as well.

The technology disclosed in Patent Document 1 is known as a conventional pneumatic tire having excellent uneven-wear resistance and excellent wet resistance. The conventional pneumatic tire includes a plurality of ribs in a tread, the ribs being formed by a plurality of main grooves extending in the tire circumferential direction. At least main grooves on the shoulder sides are provided with uneven-wear sacrifice projections configured to slip on and be in contact with a road surface when the tire is in contact with the road surface, each uneven-wear sacrifice projection having a top portion whose position is set lower than the tread surface. At least two of the main grooves are zigzag. A plurality of sipes extending along the tire-width direction is formed in an edge of each of the ribs along the circumferential direction. A plurality of projections is provided on a groove bottom of each of at least two of the main grooves along the main-groove longitudinal direction.

Patent Document 1: Japanese Patent Application Laid-open No. 2001-63316

### DISCLOSURE OF INVENTION

### Problem to be Solved by the Invention

An object of the present invention is to provide a pneumatic tire having improved uneven-wear resistance and wet resistance.

### Means for Solving Problem

To achieve the above object, a pneumatic tire according to the present invention includes a plurality of main grooves extending in a tire circumferential direction and a plurality of sub grooves that communicates with the main grooves, formed on a tread portion; a plurality of central land portions in a block shape divided by the main grooves and the sub grooves, formed in a center region of the tread portion; and a shoulder land portion in a rib shape divided by the main grooves, formed in each of shoulder regions of the tread portion. A groove area ratio A of a total area of the main grooves and the sub grooves to an area of a region between an outer-side edge of one shoulder land portion in a tire-width direction and an outer-side edge of other shoulder portion in the tire-width direction satisfies 0.25≦A≦0.32. A groove area ratio B of the total area of the main grooves and the sub grooves to an area of a region between an inner-side edge of the one shoulder land portion in the tire-width direction and an inner-side edge of the other shoulder portion in the tire-width direction satisfies 0.35≦B≦0.45.

In the pneumatic tire 1, (1) drainage performance of the tread center region improves because the central land portions have the block shape (have the sub grooves). The improvement leads to the advantage that wet resistance of the tire improves. The tread center region and the tread shoulder regions are divided with the boundaries that are the main grooves positioned outermost in the tire-width direction among the main grooves. (2) Because the shoulder land portions have the rib shape, the occurrence of initial uneven wear (for example, small heel-and-toe wear resulting from lug grooves or step wear growing along the lug grooves) in the shoulder land portions is reduced compared with, for example, the structure in which shoulder land portions includes lug grooves and the like. The reduction leads to the advantage that the uneven-wear resistance of the tire improves. (3) Because the groove area ratios A and B to the certain regions are made appropriate, the balance between the total area of the grooves in the tread and the total area of the land portions in the tread are made appropriate. The appropriate balance leads to the advantage that the wet resistance and the uneven-wear resistance of the tire are preferably maintained. The groove area ratio indicates the ratio of the total area of the main grooves and the sub grooves in the certain region to the area of the certain region of the plan view of the tread.

Furthermore, the pneumatic tire according to the present invention includes at least four of the main grooves.

In the pneumatic tire, at least four main grooves are formed. The four main grooves leads to the advantage that the wet performance (traction performance) is assured.

Moreover, the pneumatic tire according to the present invention has a tread development width W1 and a width W3 of the shoulder land portion in the tire-width direction satisfying 0.15<W3/W1<0.19.

In the pneumatic tire, the ratio of the width W3 of each of the two shoulder land portions in the tire-width direction to the tread development width W1 is made appropriate. The appropriate ratio leads to the advantage that the uneven-wear resistance and the wet resistance of the tire are assured.

Furthermore, the pneumatic tire according to the present invention has a tread development width W1 and an arrangement pitch of the sub grooves in the tire circumferential direction h satisfying 0.11<h/W1<0.26.

In the pneumatic tire, the tread development width W1 and the arrangement pitch h of the sub grooves in the tire circumferential direction are made appropriate. The appropriate width and the appropriate pitch lead to the advantage that the uneven-wear resistance and the wet resistance of the tire are assured.

Moreover, the pneumatic tire according to the present invention includes a narrow rib that extends along the shoulder land portion formed on an outer side of the shoulder land portion in the tire-width direction.

In the pneumatic tire, the narrow ribs positively wear when the tire is in contact with the road surface to function as sacrifice ribs of the shoulder land portions. The sacrifice ribs lead to the advantage that uneven wear (for example, shoulder step wear or rail wear) on the initial use of the tire is reduced and that the uneven-wear resistance of the tire thus improves.

Furthermore, the pneumatic tire according to the present invention includes a narrow groove that extends in the tire circumferential direction formed in a non-contact region on an outer side of the tread portion in the tire-width direction.

In the pneumatic tire, the narrow grooves are filled due to the contact pressures when the pneumatic tire is in contact with the road surface, and thus, the contact pressure in each of the portions of the shoulder land portions on the tire-width direction outer sides is reduced. The reduction of the contact pressures lead to the advantage that the uneven wear of the shoulder land portions is reduced and that the uneven-wear resistance of the tire thus improves.

Moreover, the pneumatic tire according to the present invention includes a sipe formed on the inner-side edge of the shoulder land portion in the tire-width direction.

In the pneumatic tire, the contact pressure of each of the portions of the shoulder land portions on the tire-width direction inner sides is reduced because of the sipes when the tire is in contact with the road surface. The reduction of the contact pressures lead to the advantage that the uneven wear (rail wear) of the shoulder land portions is reduced and that the uneven-wear resistance of the tire thus improves.

Furthermore, in the pneumatic tire according to the present invention, a dent process is performed on the inner-side edge of the shoulder land portion in the tire-width direction.

In the pneumatic tire, the contact pressure of each of the portions of the shoulder land portions on the tire-width direction inner sides is reduced because of the dent process when the tire is in contact with the road surface. The reduction of the contact pressures leads to the advantage that the uneven wear (rail wear) of the shoulder land portions is reduced and that the uneven-wear resistance of the tire thus improves.

Moreover, the pneumatic tire according to the present invention includes a sipe that goes through the shoulder land portion in a tire-width direction formed on the shoulder land portion.

In the pneumatic tire, the sipes increase the edge components of the shoulder land portions. The increase of the edge components leads to the advantage that the wet resistance improves.

Furthermore, the pneumatic tire according to the present invention includes a narrow rib that extends along a central land portion adjacent to the shoulder portion formed on an outer side of the central land portion in the tire-width direction.

In the pneumatic tire, the narrow ribs are positively wear when the tire is in contact with the road surface to function as sacrifice ribs of the central land portions. The sacrifice ribs lead to the advantage that the uneven wear (for example, punching) of the central land portions is reduced and that the uneven-wear resistance of the tire thus improves.

Moreover, the pneumatic tire according to the present invention is applied to a heavy-duty pneumatic radial tire.

In a radial tire for heavy load, the number of occurrence of uneven wear is significant and the inhibition of the occurrence is extremely highly required. For this reason, the application of the above structure for the heavy-duty pneumatic radial tire leads to the advantage that the improved effect of the wet performance and the uneven-wear resistance of the tire are obtained more remarkably.

### EFFECT OF THE INVENTION

In the pneumatic tire 1 according to the present invention, (1) the drainage performance of the tread center region improves because the central land portions have the block shape. The improvement leads to the advantage that the wet resistance of the tire improves. (2) Because the shoulder land portions have the rib shape, the occurrence of initial uneven wear of the shoulder land portions is reduced compared with, for example, the structure in which shoulder land portions include lug grooves and the like. The reduction of the initial uneven wear leads to the advantage that the uneven-wear resistance of the tire improves. (3) Because the groove area ratios A and B to the certain regions are made appropriate, the balance between the total area of the grooves in the tread and the total area of the land portions in the tread are made appropriate. The appropriate balance leads to the advantage that the wet resistance and the uneven-wear resistance of the tire are preferably maintained.

### BRIEF DESCRIPTION OF DRAWINGS

FIG. 1 is a plan view depicting a tread surface of a pneumatic tire according to an embodiment of the present invention;

FIG. 2 is an explanatory view depicting a modified example of the pneumatic tire shown in FIG. 1;

FIG. 3 is an explanatory view depicting a modified example of the pneumatic tire shown in FIG. 1;

FIG. 4 is an explanatory view depicting a modified example of the pneumatic tire shown in FIG. 1;

FIG. 5 is an explanatory view depicting a modified example of the pneumatic tire shown in FIG. 1; and

FIG. 6 is a table indicating test results of performance tests of pneumatic tires according to the embodiment of the present invention.

### EXPLANATIONS OF LETTERS OR NUMERALS

1 Pneumatic tire
21, 22 Main groove
23 Sub groove
31, 32 Central land portion
33 Shoulder land portion
41, 44 Narrow rib
42, 43 Sipe
45 Narrow groove
46 Dent process

### BEST MODE(S) FOR CARRYING OUT THE INVENTION

The present invention is explained in detail below with reference to the drawings. The embodiment does not limit the present invention. The constituents of the embodiment include constituents that can be easily replaced by those skilled in the art and constituents substantially same as the constituents of the embodiment. The modified examples disclosed in the embodiment can be arbitrarily combined within the scope obvious to those skilled in the art.

### Embodiment

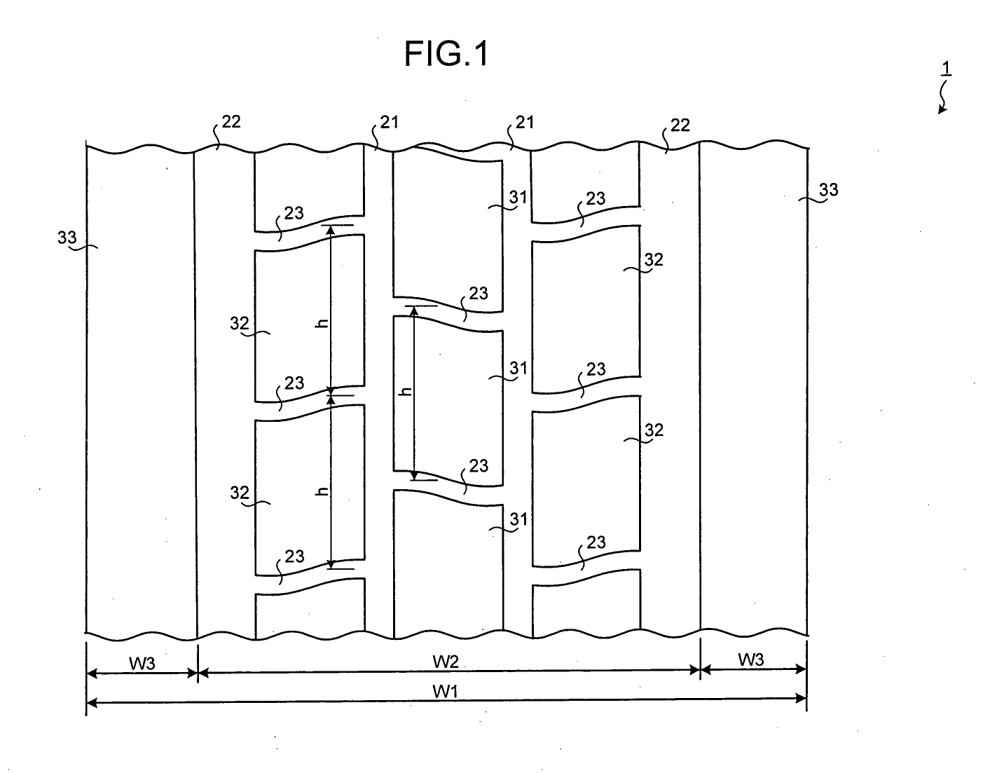

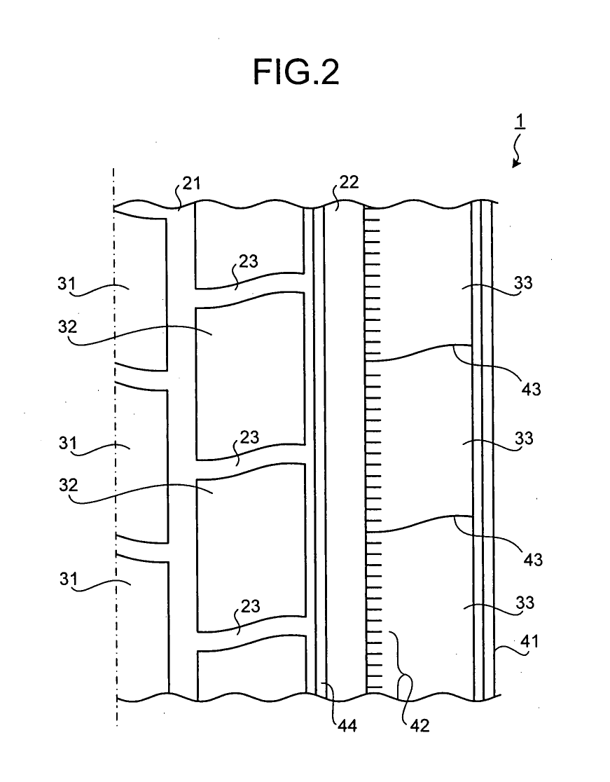

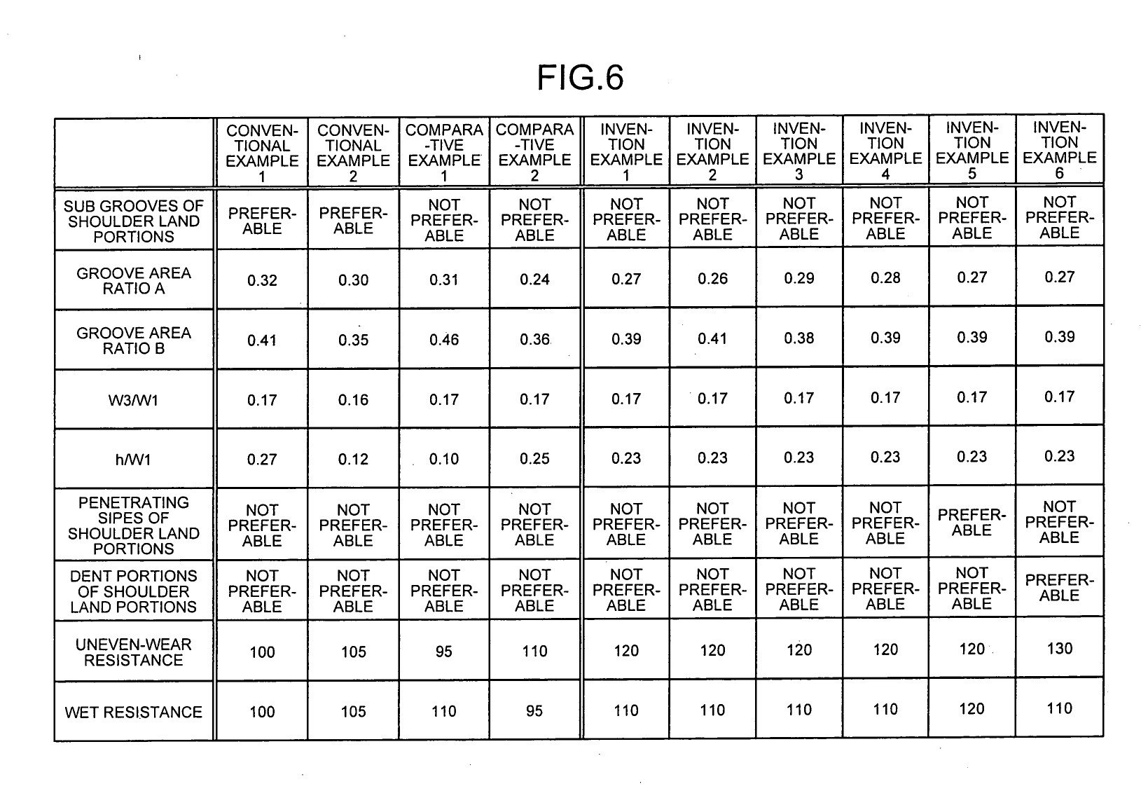

FIG. 1 is a plan view depicting a tread surface of a pneumatic tire according to an embodiment of the present invention. FIGS. 2 to 5 are explanatory views depicting modified examples of the pneumatic tire shown in FIG. 1. FIG. 6 is a table indicating test results of performance tests of pneumatic tires according to the embodiment of the present invention.

In a pneumatic tire 1, a plurality of main grooves 21 and 22 and a plurality of land portions 31 to 33 are formed in a tread (see FIG. 1). Each of the main grooves 21 and 22 extends in the tire circumferential direction and has a basic line roughly straight. The land portions 31 and 33 are formed by the main grooves 21 and 22. The land portions 31 to 33 are divided into the land portions 31 and 32 in a tread center region (hereinafter, “central land portions”) and the land portions 33 in a tread shoulder region (hereinafter, “shoulder land portions”) with the boundaries that are the main grooves 22 and 22 among the main grooves 21 and 22, the main grooves 22 and 22 being positioned outermost in the tire-width direction.

In the tread, for example, at least four of the main grooves 21 and 22 are formed and at least five lines of the land portions 31 to 33 are formed by the main grooves 21 and 22. Specifically, at least three lines of the central land portions 31, 32 and 31 are formed in the tread center region and the shoulder land portions 33 and 33 are formed respectively in the tread shoulder regions.

In each of the central land portions 31 and 32, a plurality of sub grooves 23 is formed. The sub grooves 23 communicate with the main grooves 21 and 22 and connect the adjacent main grooves 21 and 22 (allow the adjacent main grooves 21 and 22 to communicate). Hence, the central land portions 31 and 32 are each formed in a block shape by the main grooves 21 and 22 and the sub grooves 23 (see FIG. 1). Meanwhile, the sub grooves 23 are not formed in the shoulder land portions 33. Accordingly, the shoulder land portions 33 are each formed in a rib shape only by the main grooves 22.

A groove area ratio A of the total area of the main grooves 21 and 22 and the sub grooves 23 to the area of a region (region of a tread development width W1) between a first edge of one of the shoulder land portions 33 on the tire-width direction outer side and a first edge of the other shoulder land portion 33 on a tire-width direction outer side falls within a range of 0.25≦A≦0.32. In other words, the ratio of the total area of the main grooves 21 and 22 and the sub grooves 23 in the certain region to the area of the certain region is defined in the certain range. Similarly, a groove area ratio B of the total area of the main grooves 21 and 22 and the sub grooves 23 to an area of a region (region of a tread development width W2) between a second edge of the one shoulder land portion 33 on a tire-width direction inner side and a second edge of the other shoulder land portion 33 on a tire-width direction inner side falls within a range of 0.35≦B≦0.45.

In the pneumatic tire 1, (1) drainage performance of the tread center region improves because the central land portions 31 and 32 have the block shape (sub grooves 23). The improvement leads to the advantage that wet resistance of the tire improves.

(2) Because the shoulder land portions 33 have the rib shape, the occurrence of initial uneven wear (for example, small heel-and-toe wear resulting from lug grooves or step wear growing along the lug grooves) of the shoulder land portions 33 is reduced compared with, for example, the structure in which shoulder land portions include lug grooves and the like. The reduction of the initial uneven wear leads to the advantage that the uneven-wear resistance of the tire improves.

(3) Because the groove area ratios A and B to the certain regions are made appropriate, the balance between the total area of the grooves 21 to 23 in the tread and the total area of the land portions 31 to 33 in the tread are made appropriate. The appropriate balance leads to the advantage that the wet resistance and the uneven-wear resistance of the tire are preferably maintained. For example, when A<0.25 or B<0.35 is satisfied, the function of the grooves 21 to 23 is not sufficiently assured, and thus, the drainage performance of the tire reduces. When 0.32<A or 0.45<B is satisfied, the rigidity of the land portions 31 to 33 are insufficient, and thus, uneven wear tends occur in the land portions.

### First Modified Example

It is preferable in the pneumatic tire 1 that at least four of the main grooves 21 and 22 are formed (see FIG. 1). In other words, it is preferable that at least five lines of the land portions 31 to 33 be formed. Such formation leads to the advantage that the wet performance (traction performance) of the tire is assured.

### Second Modified Example

It is preferable in the pneumatic tire 1 that the tread development width W1 and the width W3 of each of the two shoulder land portions 33 and 33 in the tire-width direction have the relationship of 0.15<W3/W1<0.19. The relationship leads to the advantage that the uneven-wear resistance and the wet resistance of the tire are assured.

When W3/W1<0.15 is satisfied, for example, the width W3 of the shoulder land portion 33 is insufficient and there is the risk that shoulder wear occur. When 0.19<W3/W1 is satisfied, the groove area of the tread center region is insufficient so that the wet resistance of the tire deteriorates. Because the widths of the central land portions 31 and 32 become smaller as well, there is the risk that the heel-and-toe wear occur due to reduction of the rigidity of the central land portions 31 and 32.

The tread development width W1 is the linear distance between the two edges of the tread-patterned portion of the tire mounted on a regular rim to which a regular inner pressure is applied and no load is applied. The regular rim includes “application rim” defined by JATMA, “design rim” defined by TRA, and “measuring rim” defined by ETRTO. The regular inner pressure includes “maximum air pressure” defined by JATMA, the maximum value in “tire load limits at various cold inflation pressures” defined by TRA, and “inflation pressure” defined by ETRTO. A regular load includes “maximum load resistance” defined by JATMA, the maximum value in “tire load limits at various cold inflation pressures” defined by TRA, and “load capacity” defined by ETRTO. In the case of a pneumatic tire for passenger cars, the regular inner pressure is an air pressure of 180 kPa and the regular load is 88% of the maximum load capacity.

### Third Modified Example

It is preferable in the pneumatic tire 1 that the tread development width W1 and an arrangement pitch h of the sub grooves 23 in the tire circumferential direction have the relationship of 0.11≦h/W1≦0.26 (see FIG. 1). The relationship leads to the advantage that the wear resistance and the wet resistance of the tire are assured. When h/W1<0.11 is satisfied, the length of each of the central land portions 31 and 32 is small, and thus, there is the risk that the central land portions 31 and 32 have insufficient rigidity so that heel-and-toe wear occurs. When 0.26<h/W1 is satisfied, the groove area to the tread center region is insufficient so that the driving stability on a wet road surface deteriorates and that the total number of the sub grooves 23 decreases so that the drainage performance deteriorates.

### Fourth Modified Example

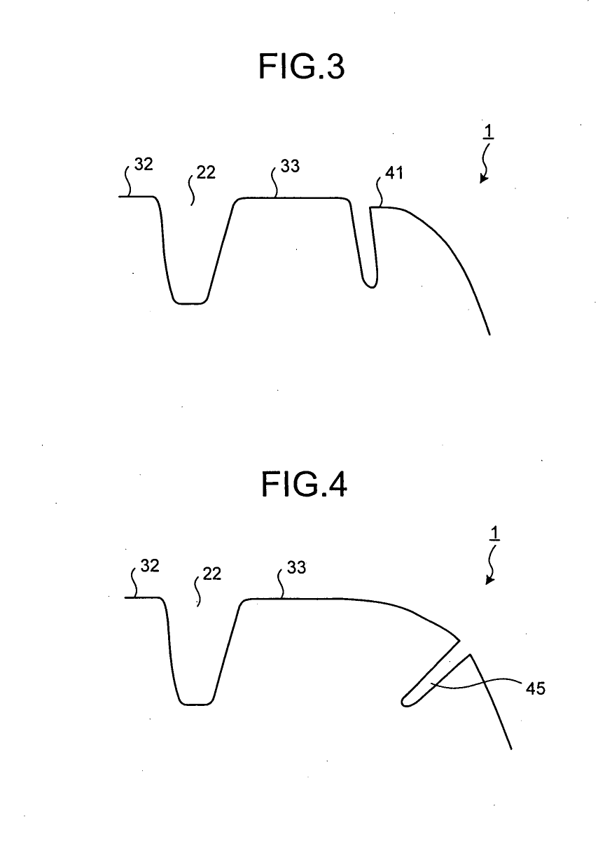

It is preferable in the pneumatic tire 1 that a narrow rib 41 extending along the shoulder land portion 33 be formed on the tire-width direction outer side of the shoulder land portion 33 (see FIGS. 2 and 3). The narrow rib 41 is formed on each of the two shoulder land portions 33 and 33. In the structure, the narrow ribs 41 positively wear to function as sacrifice ribs of the shoulder land portions 33 when the tire is in contact with the road surface. The sacrifice ribs lead to the advantage that uneven wear (for example, shoulder step wear or rail wear) of the shoulder land portions 33 on the initial use of the tire is reduced and that the uneven-wear resistance of the tire thus improves.

In place of the narrow ribs 41, a narrow groove 45 extending in the tire circumferential direction can be formed in a non-contact regions (buttresses) of the tread on the tire-width direction outer side (see FIG. 4). When viewed in a cross section in the tire-meridian direction, the narrow groove 45 has a groove width in the direction in which the narrow groove 45 slants from the shoulder of the tire to the tire-width direction inner side. The narrow groove 45 is formed on each of the two sides of the tread. In the structure, the narrow grooves 45 are filled because of contact pressures when the tire is in contact with the road surface so that the contact pressures in portions of the shoulder land portion 33 on the tire-width direction outer sides are reduced. The reduction of the contact pressures leads to the advantage that the uneven wear of the shoulder land portions 33 is reduced and that the uneven-wear resistance of the tire thus improves.

### Fifth Modified Example

It is preferable in the pneumatic tire 1 that a plurality of sipes 42 be formed on the second edge of the shoulder land portion 33 on the tire-width direction inner side (see FIG. 2). The sipes 42 each having a small sipe length and a small sipe width are arranged along the tire circumferential direction (the main groove 22). The sipe 42 are formed on each of the two shoulder land portions. 33 and 33. In the structure, the sipes 42 reduce contact pressures of portions of the shoulder land portions 33 on the tire-width direction inner sides when the tire is in contact with the road surface. The reduction of the contact pressures leads to the advantage that uneven wear (rail wear) of the shoulder land portions 33 is reduced and that the uneven-wear resistance of the tire thus improves. The size, the number, the arrangement density, and the like of the sipes 42 can be appropriately designed and changed depending on the specification of the tire and the like.

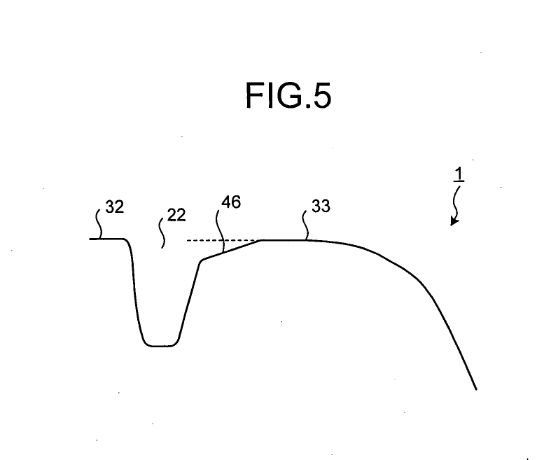

In place of the sipes 42, a dent process 46 can be performed on the second edges of the shoulder land portions 33 on the tire-width direction inner sides (see FIG. 5). The dent process 46 is configured such that the second edges of the shoulder land portions 33 on the tire-width direction inner sides (main groove 22 side) slightly dent to the groove bottom side in a cross section in the tire-meridian direction. In the structure, the contact pressures of the portions of the shoulder land portions 33 on the tire-width direction inner sides are reduced because of the dent process 46. The reduction of the contact pressures leads to the advantage that the uneven wear (rail wear) of the shoulder land portions 33 is reduced and that the uneven-wear resistance of the tire thus improves.

### Sixth Modified Example

It is preferable in the pneumatic tire 1 that sipes 43 penetrating the shoulder land portion 33 in the tire-width direction be formed in the shoulder land portion (see FIG. 2). The sipes 43 are formed on each of the shoulder land portions 33 and 33. In the structure, the sipes 43 increase the edge components of the shoulder land portions 33. The increase of the edge components leads to the advantage that the wet resistance improves.

### Seventh Modified Example

It is preferable in the pneumatic tire 1 that a narrow rib 44 extending along the central land portion 32 be formed on the tire-width direction outer side of the central land portion 32 adjacent to the shoulder land portion 33 (see FIG. 2). Specifically, the narrow rib 44 extending along the central land portion 32 in the tire circumferential direction is formed in the main groove 22 that forms the shoulder land portion 33. The narrow rib 44 is formed in each of the central land portions 32 and 32 each being adjacent to a corresponding one of the two shoulder land portions 33 and 33. In the structure, the narrow ribs 44 positively wear to function as sacrifice ribs of the central land portions 32 when the tire is in contact with the road surface. The sacrifice ribs lead to the advantage that the uneven wear (for example, punching) of the central land portions 32 is reduced and that the uneven-wear resistance of the tire thus improves.

### Application Example

It is preferable that the structure of the pneumatic tire 1 be applied for a heavy-duty pneumatic radial tire. The number of occurrence of uneven wear in a heavy-duty pneumatic radial tire is significant, and the inhibition of the occurrence is highly required. For this reason, the application of the above structure for the heavy-duty pneumatic radial tire leads to the advantage that improved effects of the wet performance and the uneven-wear resistance of the tire are obtained.

Performance Test

In the embodiment, performance tests for (1) uneven-wear resistance and (2) wet resistance were performed on a plurality of types of pneumatic tires under different conditions (see FIG. 6). In each of the performance tests, a pneumatic tire in the tire size of 295/80R22.5 is mounted on a wheel in the rim size of 22.5×8.25 and an air pressure of 900 kPa and a regular load defined by JATMA is applied to the pneumatic tire.

(1) In the tests for uneven-wear resistance, a test vehicle in which a pneumatic tire is installed in a front shaft travels a test course of 50,000 km, and then, uneven wear occurring in central land portions and shoulder land portions is measured. Based on the measurement results, index evaluation is carried out, using conventional examples as standards (100). Larger values of the evaluation results represent preferable evaluation results.

(2) In the tests for wet resistance, a test vehicle in which a pneumatic tire is installed travels on a wet road surface, and braking distances are measured from an initial speed of 40 km/h. Based on the measurement results, index evaluation is carried out, using conventional examples as standards (100). Larger values of the evaluation results represent preferable evaluation results.

In each of the pneumatic tires of Conventional examples 1 and 2, both central land portions and shoulder land portions have a block shape formed by main grooves and sub grooves (not shown, see FIG. 1). In the pneumatic tire of Conventional example 2, the groove area ratios A, B, W3/W1, and H/W1 of the region of the tread development width W1 are made appropriate.

In each of the pneumatic tires of Invention examples 1 to 6, on the other hand, only central land portions have block shapes formed by the main grooves 21 and 22 and the sub grooves 23, and the shoulder land portions 33 have the rib shape without sub grooves (see FIG. 1). The groove area ratios A, B, W3/W1, and H/W1 of the region of the tread development width W1 of the region of the tread development width W1 are made appropriate.

First, making a comparison between Conventional example 1, Comparative examples 1 and 2, and Invention examples 1 to 6, it is found that the uneven-wear resistance and the wet resistance of the tire are improved by making appropriate the groove area ratios A, B, W3/W1, and H/W1 of the region of the tread development width W1. Making a comparison between Conventional example 2 and Invention examples 1 to 6, it is found that the uneven-wear resistance and the wet resistance of the tire effectively improve more because the shoulder land portions 33 have the rib shape (without sub grooves).

Making a comparison between Invention example 1 and Invention Example 5, it is found that the wet resistance of the tire improves because the shoulder land portions 33 includes the sipes 43 that penetrates the shoulder land portions 33 in the tire-width direction. It is also found that the uneven-wear resistance of the tire improves because the shoulder land portions 33 have the dent process 46 (alternatively, the sipes 42) on the second edges on the tire-width direction inner sides.

### INDUSTRIAL APPLICABILITY

As described above, the pneumatic tire according to the present invention is advantageous because the pneumatic tire has improved uneven-wear resistance and improved wet resistance.

1-11. (canceled)

12. A pneumatic tire comprising:
a plurality of main grooves extending in a tire circumferential direction and a plurality of sub grooves that communicates with the main grooves, the main grooves and the sub grooves formed on a tread portion;
a plurality of central land portions in a block shape divided by the main grooves and the sub grooves, the central land portions formed in a center region of the tread portion; and
a shoulder land portion in a rib shape divided by the main grooves, the shoulder land portion formed in each of shoulder regions of the tread portion, wherein
a groove area ratio A of a total area of the main grooves and the sub grooves to an area of a region between an outer-side edge of one shoulder land portion in a tire-width direction and an outer-side edge of other shoulder portion in the tire-width direction satisfies 0.25≦A≦0.32, and a groove area ratio B of the total area of the main grooves and the sub grooves to an area of a region between an inner-side edge of the one shoulder land portion in the tire-width direction and an inner-side edge of the other shoulder portion in the tire-width direction satisfies 0.35≦B≦0.45.

13. The pneumatic tire according to claim 12, wherein at least four of the main grooves are formed.

14. The pneumatic tire according to claim 12, wherein a tread development width W1 and a width W3 of the shoulder land portion in the tire-width direction satisfy 0.15<W3/W1<0.19.

15. The pneumatic tire according to claim 12, wherein a tread development width W1 and an arrangement pitch of the sub grooves in the tire circumferential direction h satisfy 0.11<h/W1<0.26.

16. The pneumatic tire according to claim 12, wherein a narrow rib that extends along the shoulder land portion is formed on an outer side of the shoulder land portion in the tire-width direction.

17. The pneumatic tire according to claim 12, wherein a narrow groove that extends in the tire circumferential direction is formed in a non-contact region on an outer side of the tread portion in the tire-width direction.

18. The pneumatic tire according to claim 12, wherein a sipe is formed on the inner-side edge of the shoulder land portion in the tire-width direction.

19. The pneumatic tire according to claim 12, wherein a dent process is performed on the inner-side edge of the shoulder land portion in the tire-width direction.

20. The pneumatic tire according to claim 12, wherein a sipe that goes through the shoulder land portion in a tire-width direction is formed on the shoulder land portion.

21. The pneumatic tire according to claim 12, wherein a narrow rib that extends along a central land portion adjacent to the shoulder portion is formed on an outer side of the central land portion in the tire-width direction.

22. The pneumatic tire according to claim 12, wherein the pneumatic tire is applied to a heavy-duty pneumatic radial tire.
